(19) United States
(12) Patent Application Publication
(10) Pub. No.: US 2020/0391626 A1
(43) Pub. Date: Dec. 17, 2020

(54) Monitoring System for Unattended Children in Child Seats

(71) Applicant: Razbaby Innovative Baby Products, Inc., Miami, FL (US)

(72) Inventor: Lidia Viana, Miami, FL (US)

(21) Appl. No.: 16/600,381

(22) Filed: Oct. 11, 2019

Related U.S. Application Data
(60) Provisional application No. 62/744,630, filed on Oct. 11, 2018.

(51) Int. Cl. B60N 2/28; B60R 22/14; H04W 4/40

(52) U.S. Cl. CPC B60N 2/2812; H04W 4/40; B60R 22/14

(57) ABSTRACT

A system for monitoring and generating warnings of situations in which a safety harness of an infant carrier, car set, stroller, or other type of child safety seat is left in a buckled state, which comprises a warning apparatus with a lower portion that fits around a lower buckle of a safety harness and has a flap extending from one side of the lower portion that, once an upper buckle of the once attached to the lower buckle, can be placed by a caregiver across the top of the upper to buckle and attached to the lower portion to cause the state of a wireless transmitter to change.

This application claims the benefit of U.S. provisional application no. 62/744,630, filed Oct. 11, 2018, the entirety of which is incorporated herein by reference for all purposes.

### BACKGROUND

Infant and child car seats typically utilize a harness comprised of a groin or crotch strap and belt and at least to other straps that form lap and shoulder belts. The groin strap is usually anchored to the seat and its free end is permanently connected at one end to a hook or female portion of a buckle. Straps for the lap and shoulder are anchored at each end in a manner that allows their lengths to be adjusted and includes a latch or male portion of the buckle that slides along the respective straps with a tongue that is inserted into the hook or female portion to secure the straps. Even though in some examples their positions will be reversed, the hook or female portion will be referred to as the lower part or end of the buckle because it is typically, but does not have to be, connected to the groin strap, and the latch or male parts of the buckle will be referred to as the upper part or end of the buckle.

When the infant or child is placed in the seat, the groin strap is placed between the legs with the straps extending in front of the shoulders and across the lap. The upper parts of the buckler are then inserted into the lower end of the buckle to secure the infant or child with the harness.

### SUMMARY

The disclosure relates to methods and apparatus for monitoring and generating warnings of situations in which an infant or child that may have been left unattended in an infant carrier, infant or child car set, stroller, or other type of child safety seat in which an infant or child sits or lays and is secured with a child safety restraint system or harness for transportation.

Although a number of different types of monitoring systems are known for detecting and warning of potentially dangerous situations in which a child has been left unattended or separated from its caregiver in one of the devices, most system are complex and cannot (at least easily) be retrofitted to such devices. Many cannot be installed and setup easily by a caregiver. They often cannot be moved between child seats.

Several examples of a warning apparatus disclosed below embody features that, either singly and in various combinations, enable a warning apparatus to be used with most child restraint system. Furthermore, one or more of the features, allow a caregiver to quickly install and remove the warning apparatus from a harness, allowing it to not only be retrofitted but also quickly moved between child safety seats without requiring any changes in set up.

### BRIEF DESCRIPTION OF THE DRAWINGS

FIG. 1 is an exploded view of the components of one embodiment of a monitoring device for safety harness of a child seat.

FIG. 2 is a front side view of the monitoring device of FIG. 1 assembled.

FIG. 3 is a view of a back side of the monitoring device of FIG. 2.

FIG. 4 is a perspective view of the monitoring device of FIGS. 1-3 folded into a first position to form a first portion that will surround a lower end of a buckle for a harness of a child seat, with an end of a second portion of the monitoring device remaining free.

FIG. 5 is a perspective view of the monitoring device of FIG. 4 folded into a position in which the free end of the second portion is attached to the first portion, illustrating the position of the warning device after an upper end of the buckle of the safety harness has been inserted into the lower end and the second portion wrapped over the upper end of the buckle and attached the first portion.

FIG. 6 is a perspective view of the device of FIGS. 4-5.

FIG. 7 illustrates an alternative embodiment of a monitoring device.

FIG. 8 schematically illustrates a monitoring and warning system.

### DETAILED DESCRIPTION OF EXEMPLARY EMBODIMENTS

In the following description, like numbers refer to like elements.

In one embodiment, a monitoring apparatus that is specially adapted for monitoring a buckled state of safety harness for an infant carrier, infant or child car seat, stroller, or other type of child safety seat for transporting or safety device in which an infant or child sits or lays for transportation (generically, such items will be referred to as a child's safety seat and references to “child” are intended to include infants, toddlers and young children) comprises a radio for wirelessly communicating and an activation or arming circuit comprising two parts that, when in close proximity to each other (including, but not limited to, touching engagement) causes the mode or state of the monitoring apparatus to be set to an armed or active state. In the armed or activated state, the radio transmits a wireless signal according to a predetermined protocol, which indicates that it is armed. A device with a radio carried by the caregiver receives and monitors the wireless signal once activated. If the signal weakens or is lost before the system is disarmed or deactivated, the device generates a warning. One part of the activation or arming circuit is placed in first portion of the apparatus and the other part is placed in a second portion of the apparatus. The two portions of the apparatus are connected in a predetermined relationship. The first portion of the apparatus is installed on a lower part of the buckle connected to the groin strap, which is typically the hook or female portion, of an infant or car seat, leaving unobstructed an opening where an upper part of the buckle, which is typically the male portion or latch, is inserted. The second portion of the monitoring apparatus, attached or extending from the first portion on one side of the lower part of the buckle has a free end that is long enough for the caregiver to pass over the upper part of the buckle after it has been inserted into the lower part of the buckle, and then fastened to the first portion of the apparatus on the opposite side of the buckle. The method of fastening allows the second portion to be released. The second portion must be released from the first portion to unbuckle the harness (Note that references to upper and lower portions are always intended to refer to the male and female portions of the buckle, respectively, even if their positions are reversed.) Connecting the free end of the second portion to the first portion positions in close proximity the two parts of the activation or arming circuit, thereby placing the monitoring apparatus in an armed or activated mode.

In use, the first portion is installed on or around the buckle by a caregiver. This can be done at any time and can remain on the buckle. Once the harness has been buckled, the caregiver connects the second portion to the first portion, bringing the two parts of the activator together and causing the apparatus to be placed in an armed or activated state. To remove the child the caregiver must separate or disconnect the second portion from the first portion to remove the child or infant, automatically disarming or deactivating the system. The first portion may remain on the buckle for use later. It may also be removed from the buckle and, for example, moved to a different child safety seat.

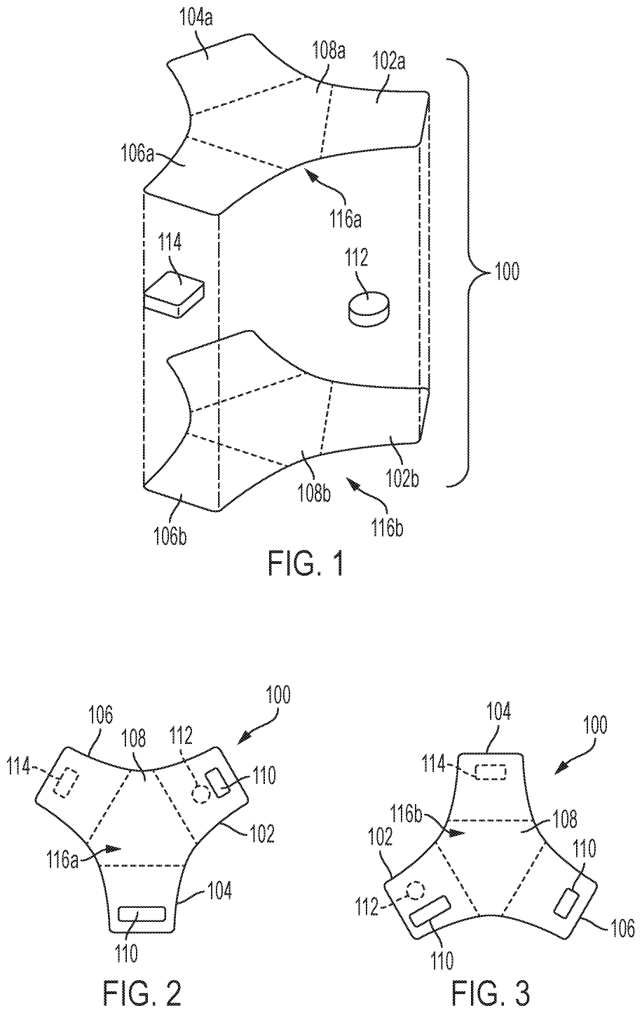

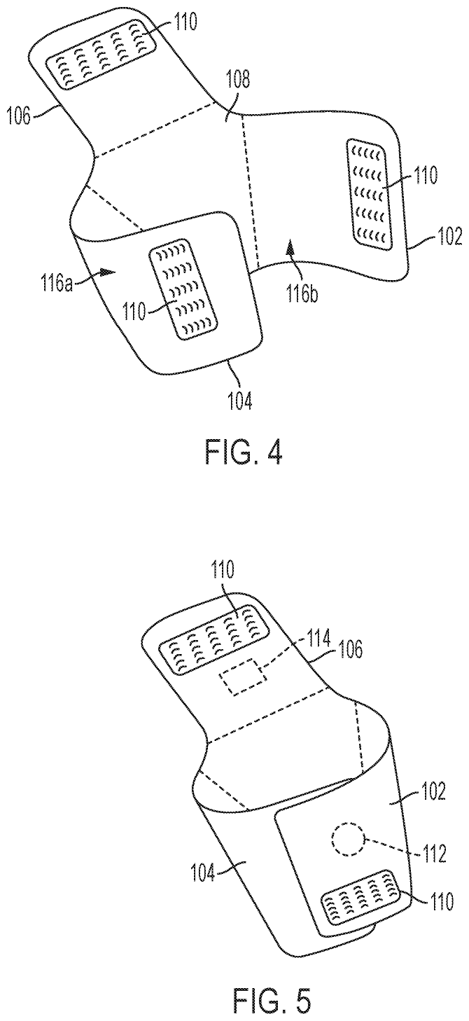

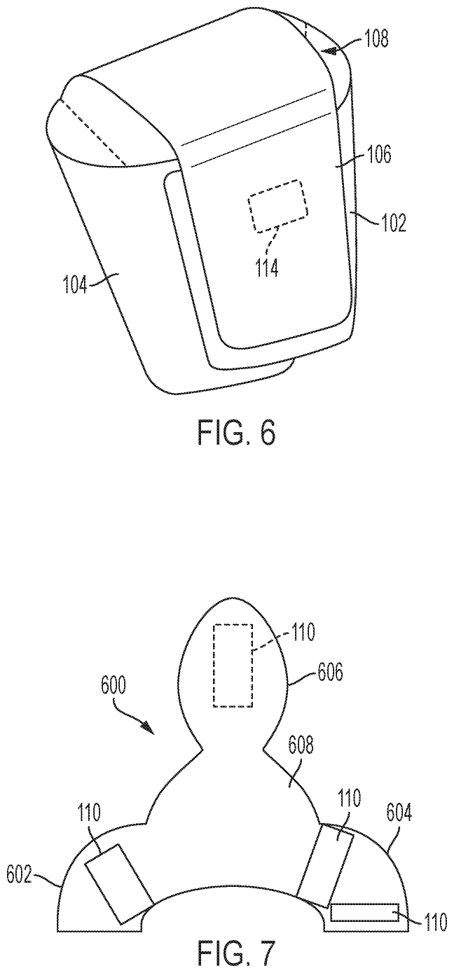

FIGS. 1 to 6 illustrate a representative non-limiting example of an embodiment of monitoring apparatus 100 for a child's safety harness. The embodiment has advantages of being very quickly installed, armed, unarmed and, if desired, removed. The monitoring apparatus is comprised of three flaps 102, 104 and 106 that extend in different directions from a shared or common center 108. Flaps 102 and 104 form straps that are configured to be wrapped around a lower end of a buckle of a child safety harness (not shown), with and free ends fastened together to form a first retaining portion that is an example of a means for retaining the warning apparatus on the lower end of the buckle, as shown by FIGS. 4 and 5. The remaining flap 108 is wrapped over the upper end of the buckle after it has been fastened to the lower end of the buckle for fastening to either of the other two flaps that comprise the first retaining portion, which is flap 102 in this particular example. This position is shown in FIG. 6. Flap 106 comprises a second retaining portion that, with the first retaining portion, holds or retains the apparatus on the buckle and prevents it from being removed without unfastening the flap 106.

In this position, a small radio 112 and an activation element 114, which are mounted in spatially separate locations in flaps 102 and 106, respectively, are brought together in close proximity, which causes arming or activation of the warning apparatus 100. (The flaps in which radio 112 and activation element 114 are located can be reversed.) This position will be referred to as an armed or activated position. To unbuckle the harness requires unfastening and moving flap 106 away from flap 102, disarming or deactivating the monitoring apparatus.

The activation element 114 comprises, for example, a piece of metal, a magnet, a circuit, an optical element, or some other type of element, the proximity of which is capable of being sensed by a proximity detector within the radio 112. The activation element 114 and the proximity detector form two parts of an activation or arming circuit, in other words an activator for the monitoring apparatus. Proximity detection may use or rely on magnetic and/or electrical fields, electrical connections, optical systems, and/or other means for detecting the proximity of the activation element 114. The proximity detector basically detects when flap 106 has been folded over and is in a position in which it can be fastened to flap 102 (or flap 104).

In this example, radio 112 represents an integrated device that is comprised of a radio with an antenna for transmitting and receiving signals, a battery for power, and a logic circuit for operating the radio according to a predetermined protocol, including the transmission of an armed or activated signal. Having a single component that includes a radio, a power supply, logic circuits, and proximity offers potentially several advantages. For example, it can be sealed to reduce the risk of water damage and/or to allow for washing and/or it can be removed for charging, washing or replacement. However, other embodiments may substitute for the radio 112 just a proximity detector that communicates with the radio 112 to signal proximity, the radio being located elsewhere within the apparatus

Although in this embodiment the radio and activation element do not physically touch—general proximity by reason of the flap 106 being fastened to one of the other two flaps being sufficient and preferred to better enable retrofitting to wider range of buckle types and sizes and less precision for quicker activation or arming—a touching or other physical connection is not precluded. In alternative embodiments, touching or connection may be required in other for activation.

The body of the monitoring apparatus is to be made from flexible or bendable material, non-limiting examples of which include textiles (fabrics or cloths), and leather, elastomers and polymers, including for example silicone rubber and various plastics, as well as composites made of one or more of these or other materials. Furthermore, it may be assembled from multiple layers or pieces of one or more materials. FIG. 1 illustrates an example of one way to assemble apparatus 100. Two pieces or layers 116a and 116b of material—a textile made of synthetic and/or natural fibers, in this example—are joined with radio 112 and activating element 114 inserted between the layers. However, other constructions can be substituted, including ones in which there are pockets to receive these or additional elements. It may also be monolithically formed from a single piece of material. If the material from which the monitoring apparatus 100 is made is molded (such as plastic or silicone rubber), the radio 112, activating element 114, contacts for recharging and/or programming, and other elements may be embedded in the material.

A fastener is used to fasten to the flaps to each other. In this example, the fasteners are hook and loop fasteners, the respective parts of which are designated by reference number 110. However, the free ends of the flaps can be fastened to each other using any type of fastener, such as buttons, clasps, latches, magnets, adhesive, or any other type of fastener or combination of fasteners that can be used to hold two pieces of fabric, cloth or other type of flexible material from which the flaps are made. It is preferred that the fastener is able to be released by the caregiver, but not an infant or child in the child safety seat, without damaging the apparatus, and preferably also able to fasten it again after it is released.

FIG. 7 illustrates an alternative embodiment of a monitoring apparatus 600 that functions in a manner similar to the embodiment shown in FIGS. 1 to 5. It has three flaps 602, 604 and 606 that are similar to the flaps 102, 104 and 106 of monitoring apparatus 100. Although not indicated, it includes a radio 112 and activation element 114. The shape of each of the flaps is more optimized to allow the monitor to be fit to a wider range of buckles.

The caregiver carries a device with a radio that is capable of receiving and monitoring the signal from radio 112, as well as logic that generates an alarm when the signal becomes too weak and/or is lost before the monitoring apparatus indicates that has been placed in an unarmed or deactivated state. This weakening of signal indicates that the caregiver is further than expected or desired from the infant.

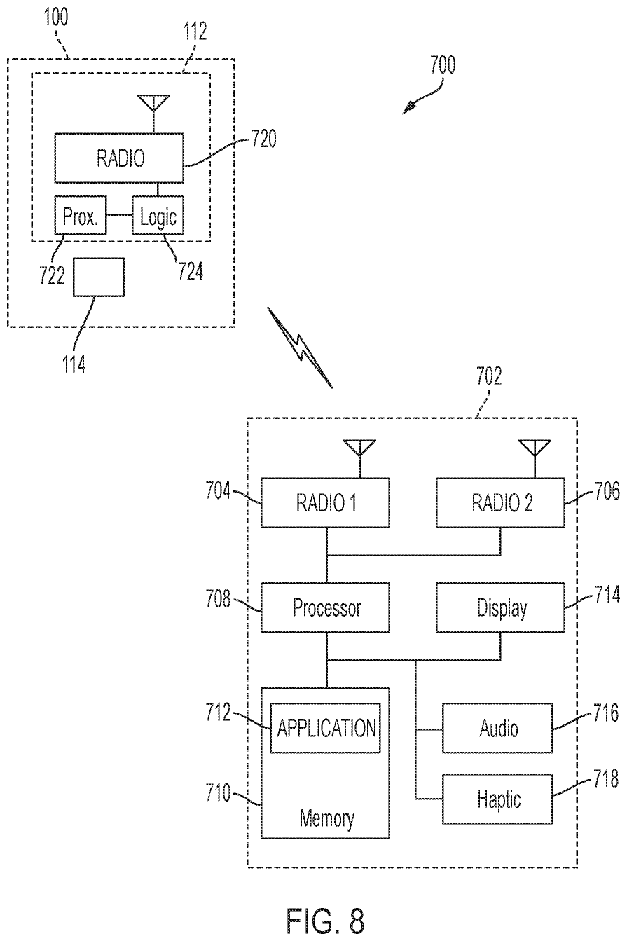

FIG. 8 schematically illustrates a high level a monitoring and warning system 700 that includes a monitoring apparatus 100 (or 600) and a device 702 carried by a caregiver. Examples of such devices includes “smartphones,” “smart watches,” and other “smart,” meaning devices capable of executing software downloaded to the device as, for example, an “application,” that have at least one, and preferably multiple radios, two of which are indicated here: radio 704 and radio 706. Radio 704 is a short range, lower power radio for communicating with the radio 112 in the monitoring apparatus 100. Radio 706 can be, for example, one for Wi-Fi or cellular communications to provide data connectivity to the Internet.

The logic for the monitoring system can be implemented using a software application 712 stored in memory 710 and executed by processor 708. The application implements the logic for processes for setting up the monitoring system, monitoring the state of the system and generating warnings. It is responsible for interfacing with lower level communication stacks (software programs for implementing communication protocols) and the operating system for the device.

The application can be downloaded by a caregiver to the smartphone. It will configure the smartphone or other device for communicating with the radio 112 in the monitoring device. It will interact with the smartphone's radio and other hardware to do this. It will establish a connection with the monitoring apparatus. If the connection to the monitoring device when it is in an armed or activated state is lost and cannot be reestablished, or the monitoring apparatus indicates an error or an unexpected change in state, or the quality of signal degrades in a manner that indicates too much separation when the monitoring device is armed, the systems enters an alarm state or mode and the processes implemented by the application will generate an alert.

To determine the quality of the signal, the caregiver's device may monitor the signal-to-noise ratio of the signal, power level, error rates or other signal parameters, or combination of them, to determine when a signal indicates too much spatial separation of the monitoring apparatus 100 and caregiver device 702.

When the system enters an alert or alarm state, the application process will cause the smartphone to generate visual, audio and/or haptic notifications using the smartphone's graphical display 714, audio system 716, and haptic system 718, and/or cause an associated device, such a smartwatch or fitness tracker, to do so. The notifications may indicate the state of the monitoring device and/or a change in state of the monitoring apparatus, such as when a connection has been lost when the monitoring apparatus was still in an armed or activated state. The process may, optionally, also be programmed to expect an acknowledgement of the alert by the caregiver.

The application may, optionally, be set up to send alerts to others by transmitting or instituting transmission of messages to people and/or services that have been set up or configured by the caregiver. They can be sent by email, text messaging, telephone, or other service, or to an application running on another caregiver's device. The types of notifications and their destinations can be set up in the application and/or in an on-line service with which the application communicates. If an online service is used, it can generate the notifications and messages, rather than the application running on the caregiver's device, upon receiving a notification from the application. Such messages may include, optionally, additional information, such the position and location of the smartphone and the last position in which a strong signal was received from radio 112.

Furthermore, according to another aspect of the system, one or more people may be designated as emergency contacts. If an alert is generated, it is sent to a remote server or on-line service. If the application process on the caregivers device does receives an acknowledgement and/or the monitoring device is deactivated or disarmed within a set period of time, it will generate a message to the remote server. Otherwise, the remote sever may be automatically send a message using any one or more communication methods (email, text messaging, or telephone, for example) to the emergency contact or to multiple emergency contacts, or a dispatch center may call directly caregiver and then the emergency contacts directly.

Radio 112 includes radio transmitter and receiver 720, a proximity detector 722, and logic 724 for performing communication and application protocols and any other processes that may be required. The logic may be implemented as firmware executed may a processor or similar device. The radio 112 may also include the logic to communicate with similar devices using a short-range wireless communication service such as Wi-Fi or Bluetooth once communication with the caregiver's device is lost for a predetermined period of time and the monitoring apparatus remains armed or activated.

The signal from the radio 112 that is part of the monitoring apparatus is generated and transmitted according a predetermined protocol. The protocol may be as simple as turning on a signal that operates like a beacon and transmits continuously or periodically. Or the wireless signal may also carry data indicating state or status of the monitoring device. The wireless signal may comprise multiple different types of signals that are being transmitted to and received from the caregiver's device 702 using established communication and application level protocols that are implemented by software on the smartphone 700 and radio 112 for maintaining a connection, detecting a loss of connection, and reestablishing a connection, as well as transmitting data on any one or more of the following: the state of the monitoring apparatus and diagnostic information, such as armed state, power levels, battery health, and other diagnostic information.

An optional feature of one embodiment includes the monitoring apparatus communicating a change in state from armed or activated to disarmed or deactivated. This change in state may be communicated by the monitoring device transmitting a predetermined message sent over the the data connection indicating that the monitoring device has been disarmed. It may also be communicated by regularly transmitting a predetermined message indicating that the monitoring device is armed and then stopping the transmission of the message. After a certain period of time of not receiving the armed message, without the connection between the monitoring device and the caregiver's device terminating or failing, the application may assume that the monitoring apparatus has been disarmed. If the application determines that the monitoring device has been disarmed, the application process may, optionally, generate an alert to the caregiver indicating the disarming of the monitor. If the caregiver did not disarm the monitoring device—perhaps the child disarmed it or it is accidentally disarmed—the caregiver may arm the monitoring device. The process may, optionally, require the caregiver to acknowledge the alert. The application process may treat the failure to acknowledge the alert within a predetermined period may be treated as an alarm state, or an alarm state if certain conditions exist, in which case it may follow the process outlined above.

The caregiver device and the monitoring apparatus are, in one embodiment, paired once without requiring repairing between periods in which the system is armed or activated.

The transmission of signals may also be sent at the initiation of the application on the caregiver's device 702 or logic that is implemented in the radio 112 in response to events or based on schedules.

The invention is not intended to be limited to any particular type of radio frequency, radio or communications protocol or application protocol, except that it is preferred, though not required, that the system uses low power signals and communication protocols that reduce power consumption in order to prolong battery power.

The radio 112 may be comprised of a single, monolithic circuit with RF, baseband and logical components and, optionally, a battery. It may also be an assembly of multiple components.

The foregoing description is of exemplary and preferred embodiments. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated or described structures or embodiments.

What is claimed is:

1. An apparatus specially adapted for monitoring a buckled state of safety harness that comprises a buckle with an upper and a lower part for connecting a groin strap to two shoulder straps, the apparatus comprising:
first and second wrapping portions that each have a predetermined shape and fixed relationship with each other, wherein the first portion is specially adapted for wrapping around the lower part of the buckle without obstructing connecting the upper part of the buckle to the lower part of the buckle, and the second wrapping portion extends from the first portion on a first side of the lower part of the buckle when the lower part is wrapped around the lower part of the buckle, the second portion comprising a free end that is capable of being passed over the upper part of the buckle, between the two shoulder straps, after the upper part of the buckle is connected with the lower part of the buckle and fastened to the first portion on a second side of the buckle that is opposite the first side of the buckle;
a transmitter for wirelessly communicating information; and
a sensor adapted for sensing when the free end of the second wrapping portion is in proximity to the first wrapping portion at the point at which it is fastened to the first wrapping portion and in response causing the transmitter to transmit a signal with information indicating that the first and second wrapping portions are fastened.
